(19) United States
(12) Patent Application Publication
(10) Pub. No.: US 2022/0331782 A1
(43) Pub. Date: Oct. 20, 2022

(54) SELECTIVE CATALYTIC REDUCTION CATALYST COMPOSITION, CATALYTIC ARTICLE COMPRISING THE SAME AND METHOD FOR PREPARING THE CATAYTIC ARTICLE

(71) Applicant: BASF CORPORATION, Florham Park, NJ (US)

(72) Inventors: Liang CHEN, Shanghai (CN); Feng ZHAO, Shanghai (CN); Jia Di ZHANG, Shanghai (CN)

(21) Appl. No.: 17/753,553

(22) PCT Filed: Sep. 15, 2020
(86) PCT No.: PCT/US2020/050789

§ 371 Date: Mar. 8, 2022

(30) Foreign Application Priority Data
Sep. 19, 2019 (CN) PCT/CN2019/106748

(51) Int. Cl. B01J 23/30; B01J 21/08; B01J 21/06; B01J 37/02; B01D 53/94; B01D 53/86

(52) U.S. Cl. CPC B01J 23/30; B01J 21/08; B01J 21/063; B01J 37/0219; B01D 53/9418; B01D 53/8628; B01D 2255/20723; B01D 2255/2098; B01D 2255/20776; B01D 2255/40; B01D 2255/30

(57) ABSTRACT

The present invention relates to a catalyst composition comprising a support, catalytically active species comprising a vanadium species, an antimony species and a tungsten species, and optionally, at least one further species selected from the group consisting of silicon species, aluminum species, zirconium species, titanium species, and cerium species; a catalytic article comprising the same, a method for preparing the catalytic article, and use of the catalyst composition or the catalytic article for selective catalytic reduction of nitrogen oxides in exhaust gases.

### CROSS-REFERENCE TO RELATED APPLICATIONS

This application claims the benefit of priority to International Application No. PCT/CN2019/106748, filed on Sep. 19, 2019 in its entirety.

### FIELD OF THE INVENTION

The present invention relates to a selective catalytic reduction (SCR) catalyst composition comprising vanadium and antimony, a catalytic article comprising the same, a method for preparing the catalytic article.

### BACKGROUND

NOx emitted as exhaust gases from mobile source such as vehicles and stationary source such as power plants would be harmful to environment and human beings. In order to remove NOx from exhaust gases, catalytic reduction methods have heretofore been developed. The catalytic reduction methods are suitable for dealing with large quantities of exhaust gases, and of these, a process comprising adding ammonia as a reducing agent to catalytically reduce NOx selectively to N₂ was reported to be superior. Various catalysts useful for selective catalytic reduction, also called SCR catalysts, have been developed for abatement of NOx from the stationary and mobile sources. The SCR catalysts are required to reduce NOx over a broad temperature range and especially at a temperature as low as possible below 300° C.

Among various SCR catalysts, a group of catalysts with vanadium as active species (vanadium SCR catalysts) is of particular interest for their low cost and sulfur resistance during a NOx abatement process.

Vanadium SCR catalysts comprising various promoters have been developed for improving NOx abatement performance. One of the promoters of interest is antimony (Sb). Such vanadium SCR catalysts comprising an antimony promoter were described, for example, in KR101065242B1, US2009/143225A1, U.S. Pat. No. 8,975,206B2, and WO2017101449A1.

With the development of such vanadium SCR catalysts comprising an antimony promoter, a concern about environment, health and safety (EHS) risk arises due to the fact that vanadium and antimony components of the catalyst may volatile at a temperature of 550° C. or higher, which for example may be encountered by the SCR catalyst in a stream of hot exhaust gases.

US2012/0058031A discloses a selective catalytic reduction catalyst system comprising a SCR catalyst material and a capture material comprising a majority phase for capturing a minority phase comprising volatile oxides or hydroxides originating from the catalyst material, wherein the minority phase of the capture material maintains a total fractional monolayer coverage on the majority phase of the capture material of about 5 or less. The majority phase of the capture material primarily comprises at least one of alumina, stabilized alumina, silica, silica-alumina, amorphous silica, titania, silica-stabilized titania, zeolites or molecular sieves or combinations thereof. It was described that the capture material may remove substantially all volatile oxides and hydroxides originating from the catalyst material.

### SUMMARY OF THE INVENTION

There remains a need for vanadium SCR catalysts having desirable NOx abatement performance at a temperature as low as possible below 300° C. and having no EHS risk, especially EHS risk of antimony.

Accordingly, it is an object of the present invention to provide SCR catalysts having desirable NOx abatement performance at a lower temperature, from which volatilization of vanadium and antimony components, especially antimony component, at a high temperature is suppressed.

It was found that the object of the present invention can be achieved by a catalyst composition comprising a support, and catalytically active species comprising a vanadium species, an antimony species and a tungsten species, and optionally at least one further species selected from the group consisting of silicon species, aluminum species, zirconium species, titanium species and cerium species, and a catalyst article comprising the catalyst composition.

Particularly, the present invention relates to following aspects.

In the first aspect of the present invention, a catalyst composition is provided, which comprises
a support,
catalytically active species comprising a vanadium species, an antimony species and a tungsten species, and
optionally, at least one further species selected from the group consisting of silicon species, aluminum species, zirconium species, titanium species, and cerium species.

In the second aspect of the present invention, a catalytic article comprising a catalytic coating on a substrate is provided, wherein the catalytic coating comprises
a support,
catalytically active species comprising a vanadium species, an antimony species and a tungsten species, and
optionally, at least one further species selected from the group consisting of silicon species, aluminum species, zirconium species, titanium species, and cerium species.

In the third aspect of the present invention, a catalytic article in form of an extruded shape body is provided, which comprises the catalyst composition according to the first aspect of the present invention.

In the fourth aspect of the present invention, a method for preparing the catalyst article according to the second or third aspect is provided, which includes steps of

1) preparing a slurry comprising particles of the support, a vanadium precursor, an antimony precursor, a tungsten precursor, and optionally one or more precursor of the at least one further species selected from the group consisting of silicon species, aluminum species, zirconium species, titanium species, and cerium species; and
2) applying the slurry onto a substrate or processing the slurry into shape bodies.

In the fifth aspect of the present invention, a method for selective catalytic reduction of nitrogen oxides present in a stream of exhaust gases by contacting the exhaust gases with the catalytic article according to the second or third aspect or with the catalytic article obtainable/obtained by the method according to the fourth aspect is provided.

In the sixth aspect of the present invention, use of the catalyst composition according to the first aspect, the catalytic articles according to the second or third aspect, or the catalytic article obtainable/obtained by the method according to the fourth aspect, for selective catalytic reduction of nitrogen oxides in exhaust gases is provided.

### DETAILED DESCRIPTION OF THE INVENTION

The present invention now will be described in details hereinafter. It is to be understood that the present invention may be embodied in many different ways and shall not be construed as limited to the embodiments set forth herein. Unless mentioned otherwise, all technical and scientific terms used herein have the same meaning as commonly understood by one of ordinary skill in the art to which this invention belongs. As used in this specification and the claims, the singular forms “a”, “an”, and “the” include plural referents unless the context clearly dictates otherwise.

### Catalyst Composition

The first aspect of the present invention provides a catalyst composition, which comprises
a support,
catalytically active species comprising a vanadium species, an antimony species and a tungsten species, and
optionally, at least one further species selected from the group consisting of silicon species, aluminum species, zirconium species, titanium species, and cerium species.

As used herein, the term “support” refers to any high surface area materials, for example a porous metal oxide material or zeolite, upon which one or more catalytically active species are applied. In the context of the invention, there is no particular restriction to the support, which may comprise for example titania, alumina, silica, zirconia, ceria, tungsten trioxide, or zeolite.

Preferably, a titania-containing support, particularly a support containing titania in a major amount (e.g. more than 50% by weight) is used in the catalyst composition according to the present invention. For example, the support may consist of titania, of titania and silica, of titania and alumina, of titania and zirconia, or of titania and tungsten trioxide. Particularly, titania in form of anatase may be used in the support. The support to be used in the catalyst composition according to the present invention may be commercially available or prepared via conventional methods known in the art.

In the catalyst composition according to the present invention, the catalytically active species are substantially supported on the support as described above. It is to be understood that the catalytically active species may also be found separate from the support in a minor amount such that the catalytical activity of the catalyst composition will not be influenced adversely. In the context of the present invention, the catalytically active species is intended to encompass not only dominant catalytic species such as vanadium, but also promoter species such as antimony and tungsten.

In one embodiment of the invention, the catalytically active vanadium species and antimony species may be in form of oxides of each, in form of a composite oxide comprising vanadium antimony, or a combination thereof, for example as described in WO2017101449A1. The catalytically active tungsten species is in form of an oxide of tungsten.

The catalyst composition according to the present invention may optionally comprise at least one further species selected from the group consisting of silicon species, aluminum species, zirconium species, titanium species and cerium species. The at least one further species may also be in form of respective oxides, i.e. SiO₂, Al₂O₃, ZrO₂, TiO₂ and CeO₂. When present, the at least one further species may or may not be on the support. In the catalyst composition according to the present invention, the at least one further species, when present, may be found on the surface of the support and/or separate from the support.

In a preferred embodiment, the catalyst composition according to the present invention comprises silicon species in form of SiO₂, which is on the surface of the support and/or separate from the support. In this embodiment, the silicon species may also function as a catalytically active species.

In a preferred embodiment, the catalyst composition according to the present invention comprises or consists of
TiO₂ as the support,
catalytically active species consisting of a vanadium species, an antimony species and a tungsten species, and
SiO₂.

Unless mentioned otherwise in the context, the amounts of the support, the catalytically active species and the optionally at least one further species in each case are calculated relative to the total weight of the support, the catalytically active species and the at least one further species if present. The weight of the catalytically active species and the weight of the at least one further species, if present, are calculated as respective oxides.

The support may be present in the catalyst composition according to the present invention in an amount of 50 to 97% by weight, preferably 61 to 95% by weight, and more preferably 75 to 90% by weight.

The vanadium species, calculated as V₂O₆, may be present in the catalyst composition according to the present invention in an amount of 1 to 10% by weight, preferably 1.5 to 8% by weight, and more preferably 2.5 to 6% by weight.

The antimony species, calculated as Sb₂O₃, may be present in the catalyst composition according to the present invention in an amount of 0.5 to 20% by weight, preferably 1.5 to 18% by weight, and most preferably 3 to 16% by weight.

The tungsten species, calculated as WO₃, may be present in the catalyst composition according to the present invention in an amount of 1 to 20% by weight, preferably 2.5 to 15% by weight, and more preferably 3 to 10% by weight.

The at least one further species, if present in the catalyst composition according to the present invention, is independently from each other in an amount of 0.5 to 20% by weight, preferably 1 to 15% by weight, more preferably 2 to 10% by weight, calculated as respective oxides, i.e., SiO₂, Al₂O₃, ZrO₂, TiO₂ and CeO₂.

In the particular embodiment wherein the catalyst composition according to the present invention comprises a silicon species as the at least one further species, silicon is present in an amount of 0.5 to 20% by weight, preferably 1 to 15% by weight, more preferably 2 to 10% by weight, calculated as SiO₂.

### Catalyst Articles

The second aspect of the present invention provides a catalytic article comprising a catalytic coating on a substrate, wherein the catalytic coating comprises
a support,
catalytically active species comprising a vanadium species, an antimony species and a tungsten species, and
optionally, at least one further species selected from the group consisting of silicon species, aluminum species, zirconium species, titanium species, and cerium species.

In embodiments according to the second aspect of the present invention, the support, the catalytically active species and the optionally at least one further species comprised in the catalytic coating are as described hereinabove for the catalyst composition according to the first aspect of the present invention. Any description and preferences described hereinabove for those components are applicable here for the catalytic coating.

The catalytic coating may be carried on the substrate as a washcoat. The term “washcoat” has its usual meaning in the art, that is a thin, adherent coating of a catalytic or other material applied to a substrate.

The term “substrate” generally refers to a monolithic material onto which a catalytic coating is disposed, for example monolithic honeycomb substrate.

For the catalytic article according to the second aspect of the present invention, there is no particular restriction to the substrate, which may be made of any materials typically used for preparing such catalysts, such as ceramic or metal. Suitable ceramic substrate may be made of any suitable refractory material, e.g., cordierite, cordierite-alumina, silicon nitride, silicon carbide, zircon mullite, spodumene, alumina-silica magnesia, zircon silicate, sillimanite, magnesium silicates, zircon, petalite, alumina, aluminosilicates and the like. Suitable metallic substrate may be made of heat resistant metals and metal alloys, such as titanium and stainless steel as well as other alloys in which iron is a substantial or major component. Specific examples of metallic substrates include the heat-resistant, base-metal alloys, especially those in which iron is a substantial or major component. The alloys may contain at least one of nickel, chromium, and aluminum in minor amounts, and may also contain small or trace amounts of one or more other metals, such as manganese, copper, vanadium and titanium.

The substrate may be a honeycomb type having a plurality of fine, substantially parallel gas flow passages extending from an inlet or an outlet face of the substrate along the longitudinal axis of the substrate, such that passages are open to fluid flow therethrough (i.e., flow-through monolithic substrate). The passages, which are essentially straight paths from their fluid inlet to their fluid outlet, are defined by walls on which the catalytic material is applied as a washcoat so that the gases flowing through the passages contact the catalytic material. Such flow-through monolithic substrates may contain up to about 900 or more flow passages (or “cells”) per square inch of cross section, although far fewer may be used. For example, the substrates may have about 50 to 600, more usually about 200 to 400, cells per square inch (“cpsi”).

Alternatively, the substrate may be a honeycomb type having a plurality of fine, substantially parallel gas flow passages extending along the longitudinal axis of the substrate wherein each passage is blocked at one end with a non-porous plug, with alternate passages blocked at opposite ends (i.e., a wall-flow monolithic substrate). The passages are defined by porous walls on which the catalytic material is applied as a washcoat. The configuration of the wall-flow substrate requires that gas flow through the porous walls of the wall-flow substrate to reach the exit. The walls defining the passages generally have a porosity of at least 40%, for example 50 to 75%, and an average pore size of at least 10 microns, for example 10 to 30 microns prior to disposition of a catalytic coating. Such wall-flow monolithic substrates may contain up to about 700 or more cpsi, such as about 100 to 400 cpsi, about 100 to 300 cpsi, and more typically about 200 to about 300 cpsi.

The flow passages of the monolithic substrates may be of any suitable cross-sectional shape and size, such as trapezoidal, rectangular, square, sinusoidal, hexagonal, oval, circular, etc.

The substrate may also be in form of metallic foils, metallic corrugated sheet or metallic monolithic foam.

The load of the catalyst composition on the substrate is generally in the range of 0.5 to 10 g/in³, preferably 1 to 7 g/in³, and more preferably 2 to 5.5 g/in³.

The third aspect of the present invention provides a catalytic article in form of an extruded shape body, which comprises the catalyst composition according to the first aspect of the present invention. In addition to the catalyst composition according to the first aspect of the present invention, the catalytic article in form of an extruded shape body also comprises components which are generated from the adjuvants used for forming the shape body, for example, binders, fillers and any other adjuvants which may survive the calcination conditions for providing the final catalytic article or which may convert into respective calcinated products such as inorganic salts or oxides and thus remain in the catalytic article.

### Method for Preparing Catalyst Articles

The fourth aspect of the present invention provides a method for preparing the catalyst article according to the second or third aspect, including steps of
1) preparing a slurry comprising particles of the support, a vanadium precursor, an antimony precursor, a tungsten precursor, and optionally one or more precursor of further species selected from the group consisting of silicon species, aluminum species, zirconium species, titanium species, and cerium species;
2) applying the slurry onto a substrate or processing the slurry into shape bodies; and
3) drying and calcining.

In the context of the invention, the vanadium precursor, antimony precursor and tungsten precursor are intended to mean vanadium-containing compounds, antimony-containing compounds, and tungsten-containing compounds respectively, which may be converted to respective oxides of vanadium, antimony and tungsten and/or any composite oxides thereof, when subjected to high temperatures in the presence of oxygen. It is to be understood that the precursors may be respective oxides of vanadium, antimony and tungsten per se.

Preferably, the vanadium precursor is selected from the group consisting of ammonium vanadate, vanadium oxalate, vanadyl oxalate, vanadium pentoxide, vanadium monoethanolamine, vanadium chloride, vanadium trichloride oxide, vanadyl sulfate, vanadium sulfate, vanadium antimonite, vanadium antimonate, and vanadium oxides.

Preferably, the antimony precursor is selected from the group consisting of antimony acetate, ethylene glycol antimony (antimony ethylene glycoxide), antimony sulfate, antimony nitrate, antimony chloride, antimonous sulfide, antimony oxides such as Sb₂O₃, and antimony vanadate.

Preferably, the tungsten precursor is selected from the group consisting of tungsten alkoxides, tungsten halides, tungsten oxyhalides, tungstic acid, ammonium tungstate, ammonium paratungstate, and ammonium metatungstate.

The precursor of further species selected from the group consisting of silicon species, aluminum species, zirconium species, titanium species and cerium species may be any compounds that can be converted to respective oxides when subjected to high temperatures in the presence of oxygen or may be respective oxides per se.

In a particular embodiment, the slurry prepared in step 1) comprises a silicon precursor. The silicon precursor is selected from the group consisting of silica sol, silicic acid, silicates such as sodium silicate, and alkoxysilanes.

It is to be understood that amounts of the support, vanadium precursor, antimony precursor, tungsten precursor and if present the precursor of the further species can be determined in accordance with the catalyst composition as described in the first aspect of the present invention.

In step 1), the slurry may be prepared in any ways known in the art without particular limitations. Any suitable solvents for forming the slurry may be used, preferably an aqueous solvent, particularly water, more preferably deionized water.

Any conventional auxiliaries such as pH adjustors, binders, organic surfactants and/or thickener may also be used, when necessary, in the preparation of the slurry for providing properties that may be desirable in subsequent steps.

In step 2), the slurry may be applied onto a substrate by any methods known in the art. For example, the substrate may be dipped into the slurry vertically so that the support and any precursors permeate into the porous structure of the substrate, removed from the slurry, and then subjected to for example air blowing so as to remove excess slurry loading. Any description and preferences as to the substrate and the load of catalyst coating thereon described in the second aspect of the present invention are applicable here.

Alternatively, in step 2), the slurry may be shaped into beads, spheres, pellets, or honeycomb bodies and the like, according to various techniques known in the art. Any conventional auxiliaries may be incorporated during the shaping process as desired, such as binders, fillers and/or plasticizers.

In step 3), the coated substrate is then dried and calcined. The drying may be carried out at a temperature in the range of −20° C. to 300° C., preferably in the range from 20° C. to 250° C., more preferably 20° C. to 200° C., in any ways known in the art. The calcination may be conducted at a temperature of at least 350° C., preferably in the range of 350° C. to 800° C., preferably in the range of 350° C. to 650° C.

### Method for Selective Catalytic Reduction of Nitrogen Oxides (NOx)

In the fifth aspect of the present invention, the present invention provides a method for selective catalytic reduction of nitrogen oxides present in a stream of exhaust gases by contacting the exhaust gases with the catalytic article according to the second or third aspect of the present invention or with the catalytic article obtained/obtainable by the method according to the fourth aspect of the present invention.

The exhaust gases may be any exhaust gases comprising NOx to be removed or reduced, which are from for example an internal combustion engine such as diesel engine, a power plant or an incinerator.

In a particular embodiment, the exhaust gases are contacted with the catalytic article at a temperature in the range of 150° C. to 650° C., or 180 to 600° C., or 200 to 550° C.

The contact of the exhaust gases with the catalytic article is conducted in the presence of a reductant. The useful reductant may be any reductants known in the art per se for reducing NOx, for example NH₃. NH₃ may be derived from urea.

In a further aspect, the present invention relates to use of the catalyst composition according to the first aspect of the present invention, or the catalytic article according to the second or third aspect of the present invention, or the catalytic article obtained/obtainable by the method according to the fourth aspect of the present invention for selective catalytic reduction of NOx, especially in exhaust gases.

The invention will be further illustrated by following Examples, which set forth particularly advantageous embodiments. While the Examples are provided to illustrate the present invention, they are not intended to limit it.

### EXAMPLES

All experiments as described hereinafter were performed at a temperature of 20° C., unless otherwise specified.

### Example 1

11.0 g ammonia metatungstate having a tungstate content corresponding to 10.0 g WO₃ was dissolved in 210 g DI water, to which 165.7 g anatase TiO₂ powder (96% solid content), 12.2 g Sb₂O₃ powder and 50.1 g solution of vanadyl oxalate in DI water having a vanadium content corresponding to 5.0 g V₂O₅ were added and stirred for 30 minutes, to obtain a suspension. Under stirring, 30% aqueous ammonia solution was added dropwise to the suspension until the pH is 7.0, and then 46.2 g SiO₂ sol having 30% SiO₂ content was added. After stirring for 1 hour, a homogenous slurry comprising 79.5% TiO₂, 2.5% V (calculated as V₂O₅), 6% Sb₂O₃, 5% W (calculated as WO₃) and 7% SiO₂, based on the total weight of those oxides, was obtained. Then a flow through honeycomb cordierite substrate of 300 cpsi with a wall thickness of 5 mils was dipped into the obtained slurry to load enough slurry. Extra loaded slurry was blown off with an air knife carefully, followed by drying with hot air at 150° C. for 15 minutes and then calcining at 450° C. for 3 hours in air. The process of washcoating, drying and calcination was repeated to load 4.5 g/in³ dry washcoat on the substrate in total.

### Example 2

11.0 g ammonia metatungstate having a tungstate content corresponding to 10.0 g WO₃ was dissolved in 210 g DI water, to which 170.6 g anatase TiO₂ powder (96% solid content), 7.5 g Sb₂O₃ powder and 50.1 g solution of vanadyl oxalate in DI water having a vanadium content corresponding to 5.0 g V₂O₅ were added and stirred for 30 minutes, to obtain a suspension. Under stirring, 30% aqueous ammonia solution was added dropwise to the suspension until the pH is 7.0, and then 46.2 g SiO₂ sol in DI water having 30% SiO₂ content was added. After stirring for 1 hour, a homogenous slurry comprising 81.5% TiO₂, 2.5% V (calculated as V₂O₅), 4% Sb₂O₃, 5% W (calculated as WO₃) and 7% SiO₂, based on the total weight of those oxides, was obtained. Then a flow through honeycomb cordierite substrate of 300 cpsi with a wall thickness of 5 mils was dipped into the obtained slurry to load enough slurry. Extra loaded slurry was blown off with an air knife carefully, followed by drying with hot air at 150° C. for 15 minutes and then calcining at 450° C. for 3 hours in air. The process of washcoating, drying and calcination was repeated to load 4.5 g/in³ dry washcoat on the substrate in total.

### Example 3 (Comparative)

176.1 g anatase TiO₂ powder (96% solid content), 12.2 g Sb₂O₃ powder and 50.1 g solution of vanadyl oxalate in DI water having a vanadium content corresponding to 5.0 g V₂O₅ were added into 210 g DI water and stirred for 30 minutes to obtain a suspension. Under stirring, 30% aqueous ammonia solution was added dropwise to the suspension until the pH is 7.0, and then 46.2 g SiO₂ sol in DI water having 30% SiO₂ content was further added. After stirring for 1 hour, a homogenous slurry comprising 84.5% TiO₂, 2.5% V (calculated as V₂O₅), 6% Sb₂O₃ and 7% SiO₂, based on the total weight of those oxides, was obtained. Then a flow through honeycomb cordierite substrate of 300 cpsi with a wall thickness of 5 mils was dipped into the obtained slurry to load enough slurry. Extra loaded slurry was blown off with an air knife carefully, followed by drying with hot air at 150° C. for 15 minutes and then calcining at 450° C. for 3 hours in air. The process of washcoating, drying and calcination was repeated to load 4.5 g/in³ dry washcoat on the substrate in total.

### Example 4 (Comparative)

Example 3 was repeated except that the amounts of anatase TiO₂ powder and Sb₂O₃ powder were adjusted to 172.4 g and 8.1 g respectively so that the obtained homogenous slurry comprises 86.5% TiO₂, 2.5% V (calculated as V₂O₅), 4% Sb₂O₃ and 7% SiO₂, based on the total weight of those oxides.

### Example 5 (Comparative)

175.9 g WO/TiO₂ powder (CristalACTiV™ DT-W5, commercially available from Tronox, with a solid content of about 96%), 12.0 g Sb₂% powder and 47.3 g solution of vanadyl oxalate in DI water having a vanadium content corresponding to 5.0 g V₂O₅ were added and stirred for 30 minutes, to obtain a suspension. Under stirring, 30% aqueous ammonia solution was then added dropwise to the suspension until the pH is 7.0, and then 46.2 g SiO₂ sol in DI water having 30% SiO₂ content was added. After stirring for 1 hour, a homogenous slurry comprising 84.5% WO₃/TiO₂ support (WO₃ accounting for 5%), 2.5% V (calculated as V₂O₅), 6% Sb₂O₃ and 7% SiO₂, based on the total weight of those oxides was obtained. Then a flow through honeycomb cordierite substrate of 300 cpsi with a wall thickness of 5 mils was dipped into the obtained slurry to load enough slurry. Extra loaded slurry was blown off with an air knife carefully, followed by drying with hot air at 150° C. for 15 minutes and then calcining at 450° C. for 3 hours in air. The process of washcoating, drying and calcination was repeated to load 4.5 g/in³ dry washcoat on the substrate in total.

### Example 6 (Comparative)

180.1 g WO₃/TiO₂ powder (CristalACTiV™ DT-W5, commercially available from Tronox, with a solid content of about 96%), 8.0 g Sb₂O₃ powder and 47.3 g solution of vanadyl oxalate in DI water having a vanadium content corresponding to 5.0 g V₂O₅ were added into 210 g DI water and stirred for 30 minutes to obtain a suspension. Under stirring, 30% aqueous ammonia solution was then added dropwise to the suspension until the pH is 7.0, and then 46.2 g SiO₂ sol having 30% SiO₂ content was added. After stirring for 1 hour, a homogenous slurry comprising 86.5% WO₃/TiO₂(WO₃ accounting for 5%), 2.5% V (calculated as V₂O₅), 4% Sb₂O₃ and 7% SiO₂, based on the total weight of those oxides, was obtained. Then a flow through honeycomb cordierite substrate of 300 cpsi with a wall thickness of 5 mils was dipped into the obtained slurry to load enough slurry. Extra loaded slurry was blown off with an air knife carefully, followed by drying with hot air at 150° C. for 15 minutes and then calcining at 450° C. for 3 hours in air. The process of washcoating, drying and calcination was repeated to load 4.5 g/in³ dry washcoat on the substrate in total.

SCR Performance Test of Catalysts from Examples 1 to 6

A cylinder sample of 1 inch in diameter and 4 inches in height was cut out from each catalyst as prepared in Examples 1 to 6. The samples were aged at 550° C. in an atmosphere consisting of 90% air and 10% steam (v/v) for 100 hours. Each sample was placed in a laboratory fixed-bed simulator. The feed gas consists of, by volume, 10% H₂O, 5% O₂, 500 ppm NO, 500 ppm NH₃ and a balance of N₂, and was supplied at a space velocity of 60,000 h⁻¹. The SCR performance test results are summarized in Table 1 below.

The SCR performance was characterized by the conversion of NOx, which was calculated according to the equation:

Conversion of NOx=(NOxᵢₙₗₑₜ−NOxₒᵤₜₗₑₜ)/NOxᵢₙₗₑₜ×100%

TABLE 1

| | Conversion of |
|---|---|
| Samples | NOx, 200° C. |
| Example 1 | 37.6% |
| Example 2 | 47.7% |
| Example 3 (Comparative) | 33.4% |
| Example 4 (Comparative) | 28.5% |
| Example 5 (Comparative) | 32.3% |
| Example 6 (Comparative) | 41.7% |

It can be seen from the results shown in Table 1, significantly higher conversions of NOx at 200° C. were achieved with the catalysts of the Examples according to the present invention comprising catalytically active tungsten species on the support, compared with the catalysts of the Comparative Examples comprising no tungsten and the catalysts of the Comparative Examples comprising tungsten as a support component (Example 1 vs. Examples 3 and 5; Example 2 vs. Examples 4 and 6).

Test for Vaporization of Vanadium and Antimony Species from the Catalysts

A cylinder sample of 1 inch in diameter and 3 inches in height was cut out from the catalyst as prepared. In the heating zone of a laboratory fixed-bed simulator positioned vertically, a section of blank cordierite substrate, a quartz wool bed of 0.5 cm (0.2 inches) in thickness, a trapping material section of 1 inch in diameter and 2 inches in height, a second quartz wool bed of 0.5 cm (0.2 inches) in thickness, and the cylinder sample of the catalyst were placed successively from bottom to top. The trapping material section was made up of a powder mixture of 4 g high surface area gamma alumina (bimodal, from Alfa Aesar) doped with 20% by weight of lanthanum oxide and 4 g high surface area gamma alumina (bimodal, from Alfa Aesar) doped with 20% by weight of calcium oxide.

The heating zone was heated at 550° C. for 18 hours with feeding from top a stream consisting of, by volume, 500 ppm NH₃, 500 ppm NO, 5% H₂O, 5% O₂ and a balance of N₂ at a flow rate of 7.5 L/min. After cooling, the trapping material was removed from the reactor and mixed with 12 mL of 16 N HNO₃, 4.0 mL of 28 N HF and 0.8 mL of 12 N HCl mixed acid solution in a Teflon vessel. The Teflon vessel was closed tightly and then heated in a microwave oven to 180° C. over 9 minutes and maintained at that temperature for another 10 minutes. A sample of the clear solution is taken from the Teflon vessel and was analyzed by ICP-MS for the vanadium and antimony concentrations. For comparison, a blank test wherein the cylinder catalyst sample was replaced with a blank cordierite substrate was also conducted. The test results are summarized in Table 2 below.

TABLE 2

| | Amounts | |
|---|---|---|
| Samples | V (ppm) | Sb (ppm) |
| Blank | 5* | 0.3* |
| Example 1 | 5.8 | 1.2 |
| Example 2 | 5 | 0.4 |
| Example 3 (Comparative) | 5.7 | 4.7 |
| Example 4 (Comparative) | 5.5 | 1 |

* the amounts of vanadium and antimony as measured in the blank test are originated from the trapping material and/or quartz wool as impurities.

It can be seen from the results shown in Table 2, the measured amounts of antimony for the catalysts of the Examples according to the present invention were much lower, compared with the catalysts of the Comparative Examples comprising no tungsten (Example 1 vs. Example 3, Example 2 vs. Example 4). It was surprisingly found that the evaporation of antimony species under high temperature can be significantly suppressed by tungsten species supported on the support in the catalysts, while desirable NOx abatement performance at a lower temperature may be provided.

1-20. (canceled)

21. A catalyst composition comprising:
a support,
catalytically active species comprising a vanadium species, an antimony species, and a tungsten species, and
optionally, at least one further species is chosen from silicon species, aluminum species, zirconium species, titanium species, and cerium species.

22. The catalyst composition according to claim 21, wherein the vanadium species and the antimony species are in form of oxides of each, in form of a composite oxide comprising vanadium and antimony, or a combination thereof; the tungsten species is in form of an oxide thereof; and the at least one further species if present, is independently from each other, in form of SiO₂, Al₂O₃, ZrO₂, TiO₂ and CeO₂.

23. The catalyst composition according to claim 21, wherein the support comprises titania, alumina, silica, zirconia, ceria, tungsten trioxide, zeolite, or any combination thereof.

24. The catalyst composition according to claim 21, wherein the vanadium species, calculated as V₂O₅, is present in the catalyst composition in an amount ranging from about 1% to about 10% by weight, relative to the total weight of the support, the catalytically active species, and the at least one further species, if present.

25. The catalyst composition according to claim 21, wherein the antimony species, calculated as Sb₂O₃, is present in the catalyst composition in an amount ranging from about 0.5% to about 20% by weight, relative to the total weight of the support, the catalytically active species, and the at least one further species, if present.

26. The catalyst composition according to claim 21, wherein the tungsten species, calculated as WO₃, is present in the catalyst composition in an amount ranging from about 1% to about 20% by weight, relative to the total weight of the support, the catalytically active species, and the at least one further species, if present.

27. The catalyst composition according to claim 21, wherein the at least one further species if present, is independently from each in an amount from about 0.5% to about 20% by weight, calculated as respective oxides SiO₂, Al₂O₃, ZrO₂, TiO₂ and CeO₂, relative to the total weight of the support, the catalytically active species, and the at least one further species.

28. The catalyst composition according to claim 21, wherein the at least one further species is a silicon species.

29. The catalyst composition according to claim 28, wherein the silicon species, calculated as SiO₂, is in an amount ranging from about 0.5% to about 20% by weight, relative to the total weight of the support, the catalytically active species, and the at least one further species.

30. The catalyst composition according to claim 21, wherein the catalytically active species consists of a vanadium species, an antimony species, and a tungsten species, and SiO₂.

31. A catalytic article comprising a catalytic coating on a substrate, wherein the catalytic coating comprises a catalyst composition according to claim 21.

32. The catalytic article according to claim 31, wherein the substrate is chosen from monolithic ceramic honeycomb substrate, metallic foils, and metallic corrugated sheet or metallic monolithic foam.

33. A catalytic article in form of an extruded shape body, which comprises the catalyst composition according to claim 21.

34. A method for preparing the catalyst article according to claim 31, wherein the method comprises:
1) preparing a slurry comprising particles of the support, a vanadium precursor, an antimony precursor, a tungsten precursor, and optionally one or more precursor of the at least one further species chosen from silicon species, aluminum species, zirconium species, titanium species, and cerium species; and
2) applying the slurry onto a substrate or processing the slurry into shape bodies.

35. The method according to claim 34, wherein the vanadium precursor is chosen from ammonium vanadate, vanadium oxalate, vanadyl oxalate, vanadium pentoxide, vanadium monoethanolamine, vanadium chloride, vanadium trichloride oxide, vanadyl sulfate, vanadium sulfate, vanadium antimonite, vanadium antimonate, and vanadium oxides.

36. The method according to claim 34, wherein the antimony precursor is chosen from antimony acetate, ethylene glycol antimony, antimony sulfate, antimony nitrate, antimony chloride, antimonous sulfide, antimony oxides such as Sb₂O₃, and antimony vanadate.

37. The method according to claim 34, wherein the tungsten precursor is chosen from tungsten alkoxides, tungsten halides, tungsten oxyhalides, tungstic acid, ammonium tungstate, ammonium paratungstate, and ammonium metatungstate.

38. The method according to claim 34, wherein the slurry prepared in step 1) comprises a silicon precursor, and the silicon precursor is chosen from silica sol, silicic acid, silicates, and alkoxysilanes.

39. A method for selective catalytic reduction of nitrogen oxides present in a stream of exhaust gases by contacting the exhaust gases with the catalytic article according to claim 31.
